(19) United States
(12) Patent Application Publication
(10) Pub. No.: US 2026/0342023 A1
(43) Pub. Date: Oct. 29, 2026

(54) POWER CONNECTOR AND SENSOR RETAINER THEREOF

(71) Applicant: BIZLINK INTERNATIONAL CORP., New Taipei City (TW)

(72) Inventors: Rican WANG, New Taipei City (TW); Xiangwu WANG, New Taipei City (TW)

(21) Appl. No.: 19/655,741

(22) Filed: Apr. 23, 2026

(30) Foreign Application Priority Data
Apr. 24, 2025 (CN) 202520788358.9

(51) Int. Cl. H01R 13/66; G01K 1/14; H01R 13/24; H01R 13/512; H01R 13/58; H01R 24/20; H01R 103/00

(52) U.S. Cl. CPC H01R 13/6683; G01K 1/14; H01R 13/245; H01R 13/512; H01R 13/5808; H01R 24/20; H01R 2103/00

(57) ABSTRACT

A power connector includes a housing, at least one conductive terminal, a sensor retainer, and a temperature sensor. The housing includes two protrusion portions defining two openings facing to each other. The at least one conductive terminal is located in the housing and exposed via the two openings of the two protrusion portions respectively. The sensor retainer is mounted to the terminal and includes a sensor housing, a middle section, a crimping section, and a pair of connection portions. The sensor housing defines a cavity. The middle section extends from the sensor housing. The crimping section extends from the middle section and configured to crimp a cable. The pair of connection portions extends laterally from opposite sides of the middle section. The temperature sensor is located within the cavity.

### CROSS - REFERENCE TO RELATED APPLICATION

This application claims priority to China Application Serial Number 202520788358.9, filed on Apr. 24, 2025, the disclosure of which is incorporated herein by reference in its entirety.

### BACKGROUND

### Field of Disclosure

The present disclosure relates to a power connector, and more particularly to a power connector equipped with a sensor retainer.

### Description of Related Art

Connectors are essential devices used to interface electronic products with power sources or other equipment. A standard connector assembly typically consists of conductive terminals, wiring, and a housing body formed by overmolding the junction between the terminals and the wires.

High-current connectors are designed for demanding environments, such as data centers. Given the significant electrical load they carry, their safety performance is critical. Reliability in these components is not only vital for data integrity but also essential for maintaining the structural stability and physical safety of the system.

Existing high-current connectors primarily rely on external temperature sensors to prevent overheating. However, because these sensors measure internal heat through the plastic housing, the accuracy is hindered by thermal resistance. This lag in heat conduction leads to a significant delay: by the time an external sensor detects an overheat condition, the internal temperature has often already exceeded safe thresholds for some time, posing a substantial safety risk.

US Patent Application Laid-open No. US20210384681A1 discloses a connector including a terminal, a housing, and a temperature sensor. However, a thermal resistance between the temperature sensor and the terminal may cause a significant delay in heat conduction.

### SUMMARY

The present disclosure provides an improved power connector to deal with the needs of the prior art problems.

In one or more embodiments, a power connector includes a housing, at least one conductive terminal, a sensor retainer, and a temperature sensor. The housing includes two protrusion portions defining two openings facing to each other. The at least one conductive terminal is located in the housing and exposed via the two openings of the two protrusion portions respectively. The sensor retainer is mounted to the terminal and includes a sensor housing, a middle section, a crimping section, and a pair of connection portions. The sensor housing defines a cavity. The middle section extends from the sensor housing. The crimping section extends from the middle section and configured to crimp a cable. The pair of connection portions extends laterally from opposite sides of the middle section. The temperature sensor is located within the cavity.

In one or more embodiments, a sensor retainer includes a sensor housing defining a cavity for receiving a sensor; a middle section extending from the sensor housing; a crimping section extending from the middle section and configured to crimp a cable; and a pair of connection portions extending laterally from opposite sides of the middle section.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 illustrates a perspective view of a sensor retainer mounted on a conductive terminal according to some embodiments of the present disclosure;

FIG. 2 illustrates an exploded view of the sensor retainer and the conductive terminal in FIG. 1;

FIG. 3 illustrates a perspective view of a power connector according to some embodiments of the present disclosure;

FIG. 4 illustrates a perspective view of a sensor retainer mounted on stacked conductive terminals according to some embodiments of the present disclosure;

FIG. 5 illustrates a perspective view of a conductive terminal array according to some embodiments of the present disclosure; and

FIG. 6 illustrates a perspective view of a housing of a power connector according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

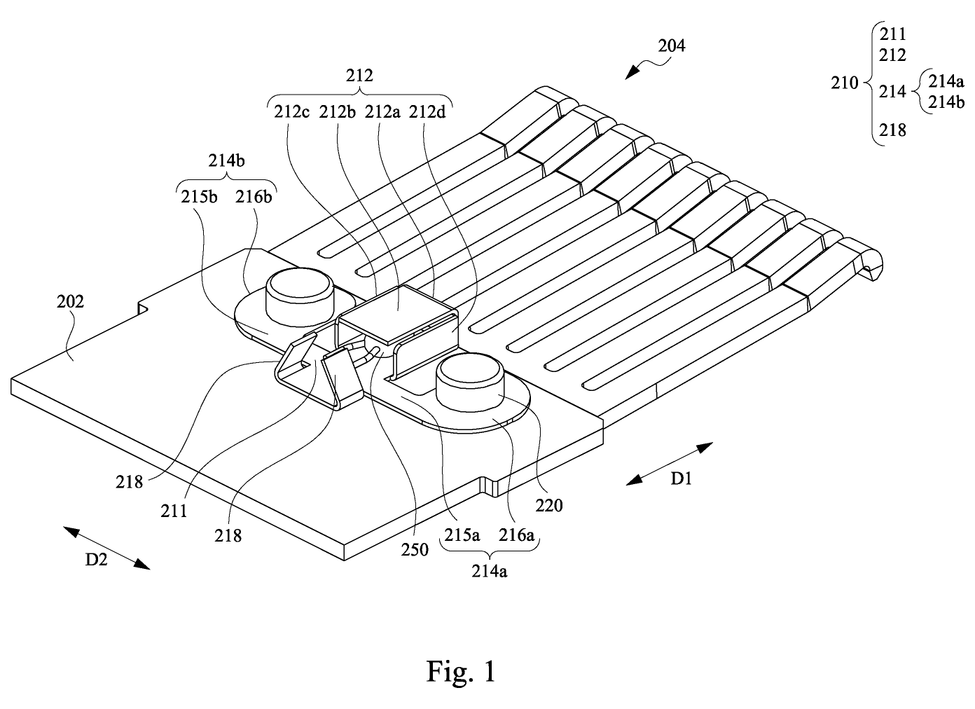

FIGS. 1-6 are illustrated in true proportion. To keep the specification concise, the proportions of each component are not listed one by one, but the proportion and position of each component should be regarded as part of the specifications. There are three orientations D1, D2 and D3 illustrated in the drawings to demonstrate the position relationship. The direction D1 is a lengthwise direction of the conductive terminal, which may also correspond to a mating direction of the power connector. The direction D2 is a widthwise direction of the conductive terminal and is perpendicular to the direction D1. Protrusion portions 152 are spaced apart along a direction D3 perpendicular to the direction D1, D2.

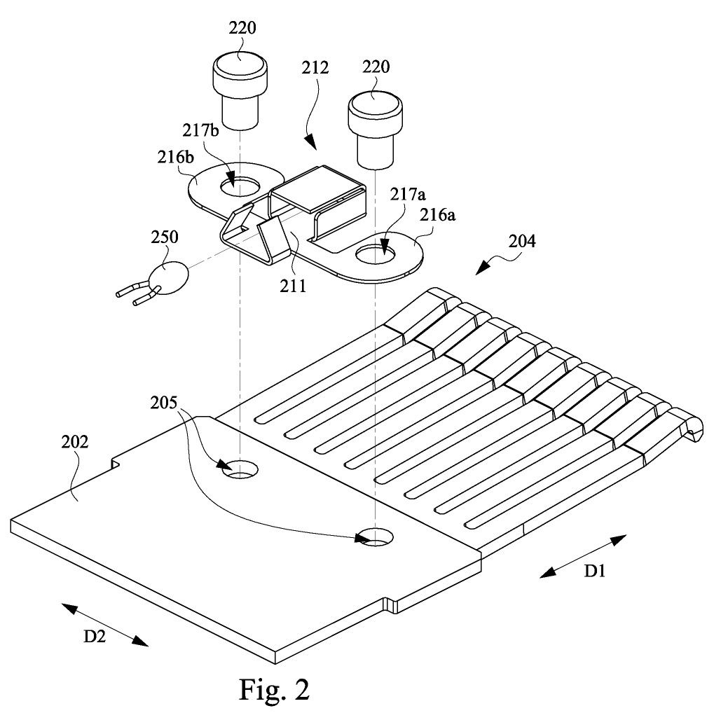

Reference is made to FIGS. 1-2, FIG. 1 illustrates a perspective view of a sensor retainer 210 mounted on a conductive terminal 202, and FIG. 2 illustrates an exploded view of the sensor retainer 210 and the conductive terminal 202 in FIG. 1. The sensor retainer 210 includes a sensor housing 212, a middle section 211, crimping sections 218, and a pair of connection portions 214. The sensor housing 212 defines a cavity for receiving a sensor, e.g., a temperature sensor 250. The middle section 211 extends from the sensor housing 212. The pair of connection portions 214 extend laterally from opposite sides of the middle section 211. The crimping sections 218 extend from the middle section 211 and configured to crimp a cable associated with the sensor.

In some embodiments of the present disclosure, the sensor housing 212, the middle section 211, the crimping section 218 and the connection portions 214 of the sensor retainer 210 are integrally formed from a metal plate by cutting and bending processes such that the sensor retainer 210 has a low thermal resistance.

In some embodiments of the present disclosure, the sensor housing 212 is a rectangular housing defined by a front wall 212a, a top wall 212b, a left wall 212c and a right wall 212d, which are made from a single metal plate. The sensor housing 212 has an opening to expose the cavity for receiving the temperature sensor 250.

In some embodiments of the present disclosure, the front wall 212a, the top wall 212b, the left wall 212c and the right wall 212d are formed by bending the single metal plate.

In some embodiments of the present disclosure, the connection portions 214 includes a left arm 214b and a right arm 214a, the left arm 214b and the right arm 214a both have a through hole (217a, 217b), through which a fastener 220 is inserted to pass and fastened to the conductive terminal 202. The fastener 220 may include rivets, blind rivets, bolts and nuts, machine screws or studs.

In some embodiments of the present disclosure, the conductive terminal 202 has connection holes 205 that are aligned with the through holes (217a, 217b) respectively. Each fastener 220 is configured to pass through corresponding through hole (217a, 217b) and connection hole 205 to secure the sensor retainer 210 on the conductive terminal 202.

In some embodiments of the present disclosure, the left arm 214b and the right arm 214a are symmetrically arranged on two sides of the middle section 211, e.g., along the direction D2, each of the left arm 214b and the right arm 214a has a ring-shaped portion(216a, 216b) through which the fastener 220 is configured to pass. Each of the connection portions 214 may further include a connecting strip (215a, 215b) connected between the ring-shaped portions (216a, 216b) and the middle section 211. The ring-shaped portion (216a, 216b) may include a circular, square, or other geometric shape that is configured to surround an opening.

In some embodiments of the present disclosure, the crimping section 218 may include two crimping arms extending from an end of the middle section 211. Top ends of two crimping arms are bent towards each other to secure cables connected to the temperature sensor 250.

When the sensor retainer 210 is mounted on a region of the conductive terminal 202 that is adjacent to an array of elastic arms 204, the middle section 211 and the connection portions 214 can be in direct contact with the region of the conductive terminal 202 to facilitate the low thermal resistance between the conductive terminal 202 and the sensor retainer 210. Therefore, the temperature sensor 250 can sense or detect the real temperature of the conductive terminal 202 in time.

In some embodiments of the present disclosure, the conductive terminal 202 includes a plurality of elastic arms 204. The elastic arms 204 all extend along the lengthwise direction D1 of the conductive terminal 202 and are arranged at equal intervals along the widthwise direction D2 of the conductive terminal 202.

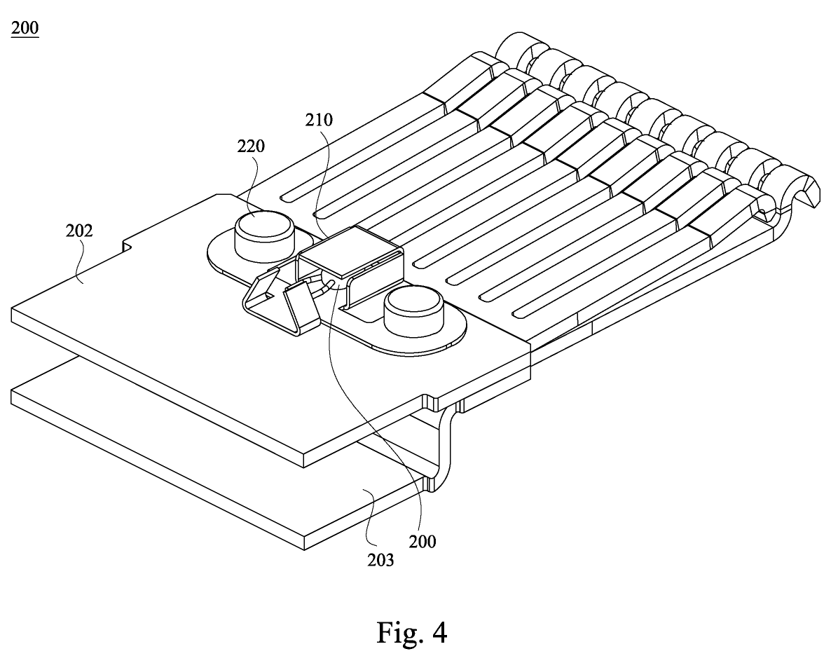

Reference is made to FIG. 4, which illustrates a perspective view of a sensor retainer 210 mounted on stacked conductive terminals (202, 203) to form a conductive terminal set 200. In some embodiments of the present disclosure, the sensor retainer 210 is mounted on a stack of two conductive terminals (202, 203) instead of single one conductive terminal 202. The temperature sensor 250 inside the sensor retainer 210 is configured to sense or detect the real temperature of the stacked conductive terminals (202, 203) in time.

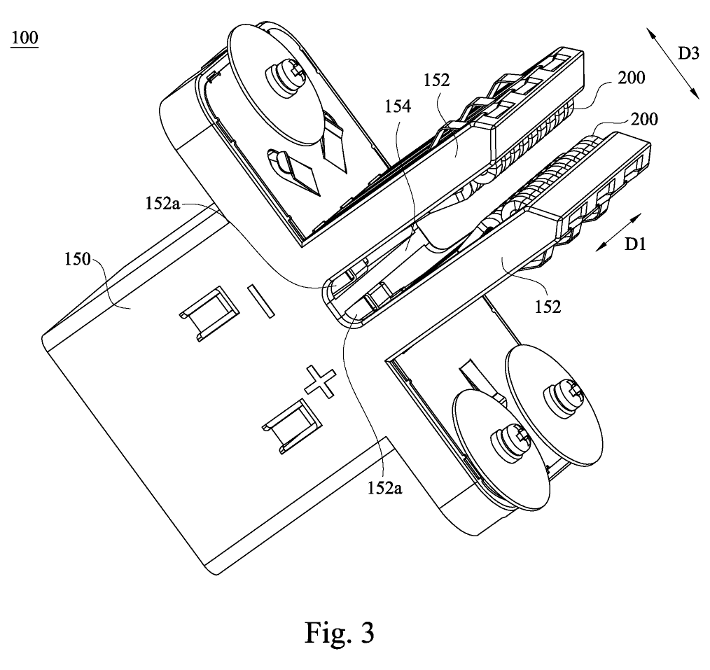

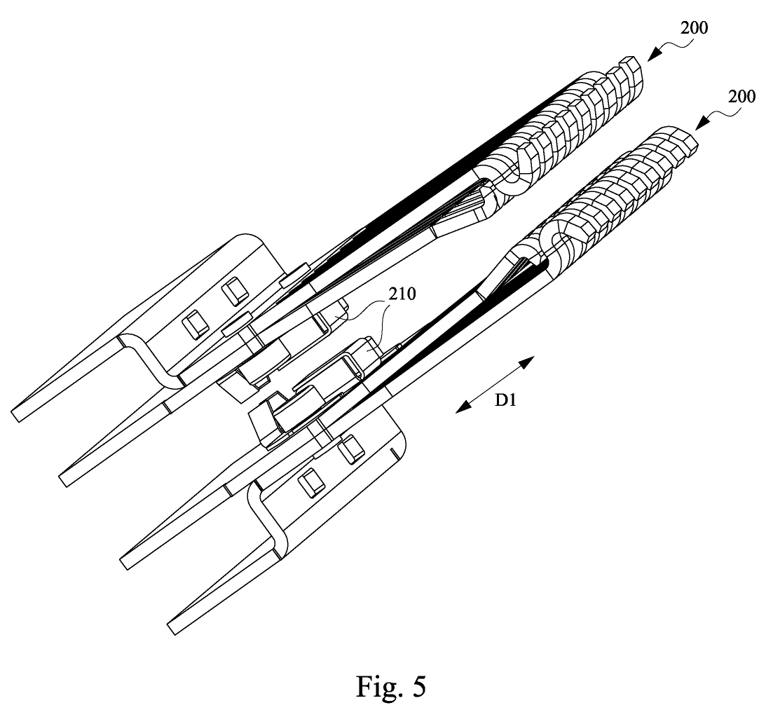

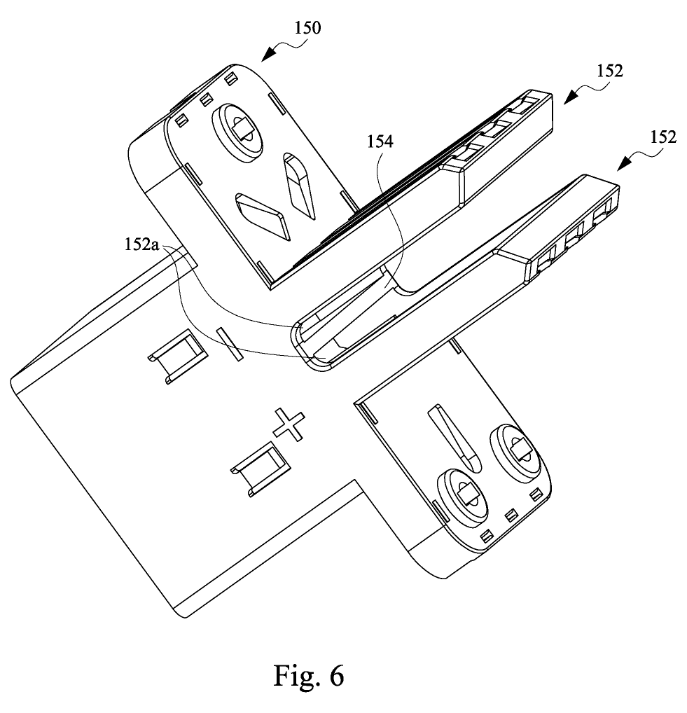

Reference is made to FIGS. 3 and 5-6, FIG. 3 illustrates a perspective view of a power connector 100, FIG. 5 illustrates a perspective view of a conductive terminal array of two conductive terminal sets 200 and FIG. 6 illustrates a perspective view of a housing 150 of the power connector 100. The housing 150 includes two protrusion portions 152 defining two openings 152a facing each other. When two conductive terminal sets 200 installed within the housing 150, the two conductive terminal sets 200 face each other. Two sensor retainers 210 mounted on the two conductive terminal sets 200 also face each other. The housing 150 is made from various plastic or polymer materials that provide electrical insulation, mechanical strength, heat resistance, and chemical durability. The two conductive terminal sets 200 are typically made from metal alloys that offer high conductivity, corrosion resistance, and durability. The power connector 100 is configured to facilitate power between different devices.

A key aspect of the disclosed solution lies in the configuration of the sensor retainer 210, which is mounted directly onto the conductive terminal 202. Unlike conventional approaches in which a temperature sensor is placed outside the connector housing and must detect heat through intervening plastic materials, the sensor retainer 210 establishes a direct thermal pathway between the conductive terminal 202 and the temperature sensor 250. Specifically, the middle section 211 and the connection portions 214 are configured to be in direct physical contact with a region of the conductive terminal 202, particularly a region adjacent to the elastic arms 204 where current flow and therefore heat generation is most significant. This direct contact minimizes thermal resistance and eliminates the delay associated with heat conduction through insulating materials, thereby allowing the temperature sensor 250 to sense the real temperature of the conductive terminal 202 in a timely and accurate manner.

Furthermore, the structural design of the sensor retainer 210 contributes substantially to reducing thermal resistance. The sensor housing 212, the middle section 211, the crimping sections 218, and the connection portions 214 are integrally formed from a single metal plate through cutting and bending processes. This integral metallic construction ensures continuous thermal conductivity throughout the sensor retainer 210, avoiding the thermal discontinuities that would otherwise arise from multi-component assemblies or the use of insulating materials. As a result, heat generated in the conductive terminal 202 can be efficiently transferred through the connection portions 214 and the middle section 211 to the sensor housing 212, where the temperature sensor 250 is located. This configuration effectively transforms the sensor retainer 210 into a low-resistance thermal bridge, thereby overcoming the limitations of conventional external sensing schemes.

The geometry of the sensor housing 212 further enhances the responsiveness and reliability of the temperature sensing function. The sensor housing 212 is defined by the front wall 212a, the top wall 212b, the left wall 212c, and the right wall 212d, all formed from a single metal plate. The sensor housing 212 further defines an opening located at a rear end opposite to the front wall 212a, wherein the temperature sensor 250 is configured to be inserted into the cavity through the opening along the direction D1. This enclosure defines a cavity that directly accommodates the temperature sensor 250 while maintaining close proximity to the conductive terminal 202. The opening of the sensor housing 212 allows the temperature sensor 250 to be positioned with minimal obstruction between it and the heat source, thereby further reducing thermal lag. Additionally, the metallic enclosure can provide a degree of shielding and mechanical protection for the temperature sensor 250, ensuring stable operation under high-current and high-temperature conditions.

The fastening mechanism defined by the connection portions 214 also plays a crucial role in ensuring both mechanical stability and thermal efficiency. Each of the left arm 214b and the right arm 214a includes through holes 217a, 217b that align with corresponding connection holes 205 in the conductive terminal 202. Fasteners 220, such as rivets or screws, are inserted through these aligned holes to securely fix the sensor retainer 210 onto the conductive terminal 202. This fastening arrangement not only ensures that the sensor retainer 210 remains firmly attached during operation and under mechanical stress, but also enhances thermal resistance by maintaining consistent and intimate contact between the metallic surfaces. The inclusion of ring-shaped portions 216a, 216b and connecting strips 215a, 215b further distributes mechanical load and ensures uniform stress across the contact interface, thereby preventing localized gaps that could increase thermal resistance.

Another important feature is the placement of the sensor retainer 210 in proximity to the elastic arms 204 of the conductive terminal 202. The elastic arms 204 are arranged along the lengthwise direction D1 and spaced along the widthwise direction D2, forming regions where electrical contact and current density are concentrated. These regions are typically the primary sources of heat generation within the conductive terminal 202. By positioning the sensor retainer 210 adjacent to this array, the temperature sensor 250 is effectively located at a thermally critical position, enabling it to detect temperature rises at the earliest possible stage. This strategic placement ensures that the sensing system responds not merely to averaged or delayed temperature changes, but to the actual peak temperatures experienced during operation.

The crimping sections 218 further contribute to the overall functionality by providing a reliable electrical and mechanical connection for cables associated with the temperature sensor 250. The two crimping arms extending from an end of the middle section 211 are bent toward each other to secure the sensor cables, ensuring stable signal transmission from the temperature sensor 250. This integrated cable management reduces the likelihood of signal loss or noise, thereby enhancing the accuracy and reliability of temperature monitoring.

In addition to single-terminal applications, the disclosed design is also adaptable to more complex configurations, such as stacked conductive terminals 202 and 203 forming a conductive terminal set 200. In such configurations, the sensor retainer 210 is mounted to monitor the combined thermal behavior of multiple conductive terminals. This is particularly advantageous in high-current applications where multiple terminals are used in parallel to handle increased electrical loads. By enabling a single temperature sensor 250 to monitor the real-time temperature of the stacked conductive terminals 202, 203, the design provides an efficient and scalable solution for thermal management in high-density connector systems.

Finally, when integrated into a power connector 100, the benefits of the disclosed sensor retainer 210 become even more apparent. The housing 150, made from insulating plastic or polymer materials, provides the necessary electrical insulation and mechanical protection. However, unlike conventional designs where such housing materials impede heat transfer to external sensors, the present invention bypasses this limitation by embedding the sensing mechanism within the conductive terminal structure itself. The conductive terminal sets 200, positioned within the housing 150 and facing each other, each carry a sensor retainer 210 that directly monitors their temperature. This internal sensing approach ensures that the temperature sensor 250 operates independently of the thermal characteristics of the housing 150, thereby eliminating the inaccuracies and delays associated with external sensing.

In summary, the integrally formed metallic sensor retainer 210 has its direct attachment to the conductive terminal 202, and the strategic placement of the temperature sensor 250, to collectively provide a low thermal resistance pathway for heat transfer. This enables real-time, accurate temperature detection at the source of heat generation, effectively overcoming the limitations of conventional external temperature sensors. As a result, the disclosed design significantly enhances the safety, reliability, and performance of high-current connectors in demanding applications.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A power connector comprising:
a housing comprising two protrusion portions defining two openings facing to each other;
at least one conductive terminal disposed in the housing and exposed via the two openings of the two protrusion portions respectively;
a sensor retainer mounted to the conductive terminal, the sensor retainer comprising:
a sensor housing defining a cavity;
a middle section extending from the sensor housing;
a crimping section extending from the middle section and configured to crimp a cable; and
a pair of connection portions extending laterally from opposite sides of the middle section; and
a temperature sensor disposed within the cavity.

2. The power connector of claim 1, wherein the conductive terminal comprises a plurality of elastic arms.

3. The power connector of claim 2, wherein the elastic arms are arranged at equal intervals along a widthwise direction of the conductive terminal.

4. The power connector of claim 1, wherein the connection portions comprises a left arm and a right arm, each of the left arm and the right arm has a through hole.

5. The power connector of claim 4, wherein the conductive terminal has a plurality of connection holes that are aligned with the through holes respectively.

6. The power connector of claim 5, further comprising a fastener configured to pass through a corresponding pair of the through holes and the connection holes.

7. The power connector of claim 6, wherein the left arm and the right arm are symmetrically arranged on two sides of the middle section, each of the left arm and the right arm has a ring-shaped portion through which the fastener is configured to pass.

8. The power connector of claim 7, wherein each of the connection portions further comprises a connecting strip connected between the ring-shaped portion and the middle section.

9. The power connector of claim 1, wherein the crimping section comprises two crimping arms extending from an end of the middle section and bent toward each other.

10. The power connector of claim 1, wherein the sensor housing is a rectangular housing defined by a front wall, a top wall, a left wall and a right wall.

11. The power connector of claim 1, wherein the sensor housing, the middle section, the crimping section and the connection portions are integrally formed from a metal plate by cutting and bending processes.

12. A sensor retainer comprising:
a sensor housing defining a cavity for receiving a sensor;
a middle section extending from the sensor housing;
a crimping section extending from the middle section and configured to crimp a cable; and
a pair of connection portions extending laterally from opposite sides of the middle section.

13. The sensor retainer of claim 12, wherein the sensor housing, the middle section, the crimping section and the connection portions are integrally formed from a metal plate by cutting and bending processes.

14. The sensor retainer of claim 13, wherein the sensor housing is a rectangular housing defined by a front wall, a top wall, a left wall and a right wall.

15. The sensor retainer of claim 14, wherein the front wall, the top wall, the left wall and the right wall are formed by bending the metal plate.

16. The sensor retainer of claim 12, wherein the connection portions comprises a left arm and a right arm, each of the left arm and the right arm has a through hole.

17. The sensor retainer of claim 16, further comprising a fastener configured to pass through the through hole.

18. The sensor retainer of claim 17, wherein the left arm and the right arm are symmetrically arranged on two sides of the middle section, each of the left arm and the right arm has a ring-shaped portion through which the fastener is configured to pass.

19. The sensor retainer of claim 18, wherein each of the connection portions further comprises a connecting strip connected between the ring-shaped portion and the middle section.

20. The sensor retainer of claim 12, wherein the crimping section comprises two crimping arms extending from an end of the middle section and bent toward each other.
